(19) United States
(12) Patent Application Publication
(10) Pub. No.: US 2009/0094017 A1
(43) Pub. Date: Apr. 9, 2009

(54) Multilingual Translation Database System and An Establishing Method Therefor

(76) Inventors: Shing-Lung Chen, Kaohsiung (TW); Chuan-Wen Chiang, Taipei County (TW); Cheng-Sung Chang, Nantou County (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/332,453

(22) Filed: Dec. 11, 2008

(30) Foreign Application Priority Data
May 9, 2007 (TW) 096133145

(51) Int. Cl. G06F 17/28

(52) U.S. Cl. 704/3

(57) ABSTRACT

A method for building a multilingual translation database system includes the steps of: providing a plurality of multilingual sentence pairs or multilingual sentence-fragment pairs in a translation database, each of the multilingual sentence pairs or the multilingual sentence-fragment pairs formed with a source language and a target language; selecting repeated sentence structures or repeated sentence fragments from the multilingual sentence pairs or the multilingual sentence-fragment pairs; and defining or qualifying at least one repeated key sentence or key sentence fragment of the repeated sentence structures or the repeated key sentence-fragment structures with a predetermined degree of repeat frequency.

### BACKGROUND OF THE INVENTION

1. Field of the Invention

The present invention relates to a multilingual translation database system and an establishing method therefor. More particularly, the present invention relates to the multilingual translation database system and the establishing method therefor utilizing repeated key sentences or repeated key sentence fragments selected from multilingual language data for improving the speed of translation.

2. Description of the Related Art

In general, peoples in different nations must permanently rely on linguistic translation in communication. There regularly exist a need of translation for interacting peoples and interchanging knowledge in different nations. For example, peoples in Taiwan can study advanced science and technologies of other foreign countries via technical translation. Hence, the technical translation is very important in globalizing, and studying science and technologies nowadays.

A personal skill or ability in translation is a very important tool for linguists. Currently, translation programs in college education focus on training the personal skill of sentence-by-sentence translation such that most of peoples usually translate the text in the manner of sentence by sentence from beginning to end. On the other hand, translators have a choice of using a computer-aided translation tool (e.g. translation software) to speed up the efficiency of mass translation. However, a number of limits exist for using the conventional translation computer software. Hence, there is a need of improving the conventional translation computer software.

Typically, there are two types of translation computer software available on the market, including machine translation type and translation memory (TM) database type. The machine translation software can convert a language (i.e. source language) into a different language (i.e. target language). The conventional machine translation software can be functioned to systematically analyze and judge the foreign-language sentences in executing machine translation. Disadvantageously, such a type of the translation software limits sentence structures of the translated language (i.e. target language) in those of the original language (i.e. source language) such that the translated language generated from the machine translation software does not have correct grammar. As a result, the translated language generated by the machine translation software is completely vague and awkward in reading. To solve this problem, the translation software based on the translation memory database has been developed.

The translation memory database has been designed due to the fact that each language has a great number of sentence structures which are repeatedly used in translation. However, there are a number of identical or similar sentence structures repeatedly used in translation for a particular or predetermined technique field. In view of this, these identical or similar sentence structures are stored in the translation memory database for comparing them with sentences of the source language text and calculating a degree of similarity in future translation. In utilizing the translation memory database, the identical or similar sentence structures existing in the original text are analyzed and used in a new translation work. An adequate amount of the sentence structures stored in the translation memory database can obviously reduce the amount of new translation work. However, such a type of the translation memory database software during use exists some drawbacks as follows:
1. The sentence structures collected in the translation memory database may not frequently appear in normal translation such that the utility rates of these sentence structures are relatively low in translation work.
2. Users (e.g. human translators) require personally building the contents of the translation memory database prior to use it. Accordingly, this results in a great deal of wasted work and time in building the translation memory database.
3. The contents of the translation memory database built by each personal user may focus on a single technique field, and may not contain a broader scope of the technical field. However, the contents of the translation memory database must be rebuilt while using in translation of another different technical field.

As is described in greater detail below, the present invention intends to provide a multilingual translation database system and an establishing method therefor in such a way as to mitigate and overcome the above problem.

### SUMMARY OF THE INVENTION

The primary objective of this invention is to provide a multilingual translation database system formed from sentence structures or sentence-fragment structures each of which having a predetermined degree of the repeat frequency. Each of the sentence structures or the sentence-fragment structures is formed with at least one corresponding target language translation. Accordingly, the present invention is successful in enhancing a speed of translation work.

Another objective of this invention is to provide an establishing method for the multilingual translation database system including the steps of: collecting, converting, classifying, analyzing, revising, storing and testing. Accordingly, the present invention is successful in building the multilingual translation database system.

The method for building the multilingual translation database system in accordance with an aspect of the present invention includes the steps of:
providing a plurality of multilingual sentence pairs or multilingual sentence-fragment pairs in a translation database, each of the multilingual sentence pairs or the multilingual sentence-fragment pairs formed with a source language and a target language;
selecting repeated sentence structures or repeated sentence fragments from the multilingual sentence pairs or the multilingual sentence-fragment pairs;
defining or qualifying at least one repeated key sentence or key sentence fragment of the repeated sentence structures or the repeated key sentence-fragment structures with a predetermined degree of the repeat frequency.

In a separate aspect of the present invention, the method further including the step of: collecting the multilingual sentence pairs or the multilingual sentence-fragment pairs via Internet by using a computer program.

In a further separate aspect of the present invention, the method further including the step of: converting a first format of the multilingual sentence pairs or the multilingual sentence-fragment pairs into a second format by using recognition software.

In a yet further separate aspect of the present invention, the method further including the step of: revising the repeated key sentence or the repeated key sentence fragment, and adding the repeated key sentence or the repeated key sentence fragment to the translation database.

The multilingual translation database system in accordance with an aspect of the present invention includes:
a translation database;
a plurality of multilingual sentence pairs or multilingual sentence-fragment pairs stored in the translation database;
a plurality of repeated sentence structures or repeated sentence-fragment structures selected from the multilingual sentence pairs or the multilingual sentence-fragment pairs;
a plurality of repeated key sentences or repeated key sentence fragments retrieved from the repeated sentence structures or the repeated sentence-fragment structures;
wherein each of the repeated key sentences or the repeated key sentence fragments has a predetermined degree of the repeat frequency.

In a separate aspect of the present invention, the multilingual sentence pairs or the multilingual sentence-fragment pairs are collected via Internet by using a computer program.

In a yet further separate aspect of the present invention, the multilingual sentence pairs or the multilingual sentence-fragment pairs are converted from a first format of into a second format by using recognition software.

In a yet further separate aspect of the present invention, some of the repeated key sentences or the repeated key sentence fragments are revised and added to the translation database.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of an establishing method of a multilingual translation database system in accordance with a preferred embodiment of the present invention.

### DETAILED DESCRIPTION OF THE INVENTION

It is noted that a multilingual translation database system of the present invention can be implemented on a variety of different computing equipment, including stand-alone personal computers, networked computers, laptop computers, workstations, or the like; and an establishing method for the multilingual translation database system of the present invention can be formed with computer-executable process steps.

Thorough the specification, the term “repeat frequency” means that the number of times for sentences or sentence fragments appears in database, and may be automatically counted by computing equipment. The term “key,” as used herein, means that repeated sentences or repeated sentence fragments found in database are identified or qualified by a predetermined degree of repeat frequency, and may be automatically executed by computer-executable process steps.

The method for building the multilingual translation database system in accordance with a preferred embodiment of the present invention includes the steps of:
providing a plurality of multilingual sentence pairs or multilingual sentence-fragment pairs in a translation database, each of the multilingual sentence pairs or the multilingual sentence-fragment pairs formed with a source language and a target language (such as Chinese and English, Chinese and France, Chinese and German or English and German);
selecting repeated sentence structures (such as complete sentences) or repeated sentence fragments (such as incomplete sentences) from the multilingual sentence pairs or the multilingual sentence-fragment pairs, wherein the repeated sentence structures or repeated sentence fragments may be calculated manually or automatically by computing equipment;
defining or qualifying at least one repeated key sentence or key sentence fragment of the repeated sentence structures or the repeated key sentence-fragment structures with a predetermined degree of the repeat frequency.

In another preferred embodiment of the present invention, the method further including the step of: collecting the multilingual sentence pairs or the multilingual sentence-fragment pairs via Internet by using a computer program, or via computer-readable medium (such as CD-ROM). In another preferred embodiment of the present invention, the method further including the step of: converting a first format of the multilingual sentence pairs or the multilingual sentence-fragment pairs into a second format by using recognition software or other computer programs. In another preferred embodiment of the present invention, the method further including the step of: revising the repeated key sentence or the repeated key sentence fragment, and adding them to the translation database.

The multilingual translation database system in accordance with a preferred embodiment of the present invention includes:
a translation database which is implemented by computing equipment including a network connection;
a plurality of multilingual sentence pairs or multilingual sentence-fragment pairs provided or stored in the translation database;
a plurality of repeated sentence structures or repeated sentence-fragment structures selected from the multilingual sentence pairs or the multilingual sentence-fragment pairs;
a plurality of repeated key sentences or repeated key sentence fragments retrieved from the repeated sentence structures or the repeated sentence-fragment structures;
wherein each of the repeated key sentences or the repeated key sentence fragments has a predetermined degree of repeat frequency.

In another preferred embodiment of the present invention, the multilingual sentence pairs or the multilingual sentence-fragment pairs are collected via Internet by using a computer program. In another preferred embodiment of the present invention, the multilingual sentence pairs or the multilingual sentence-fragment pairs are converted from a first format of into a second format by using recognition software. In another preferred embodiment of the present invention, some of the repeated key sentences or the repeated key sentence fragments are revised and added to the translation database.

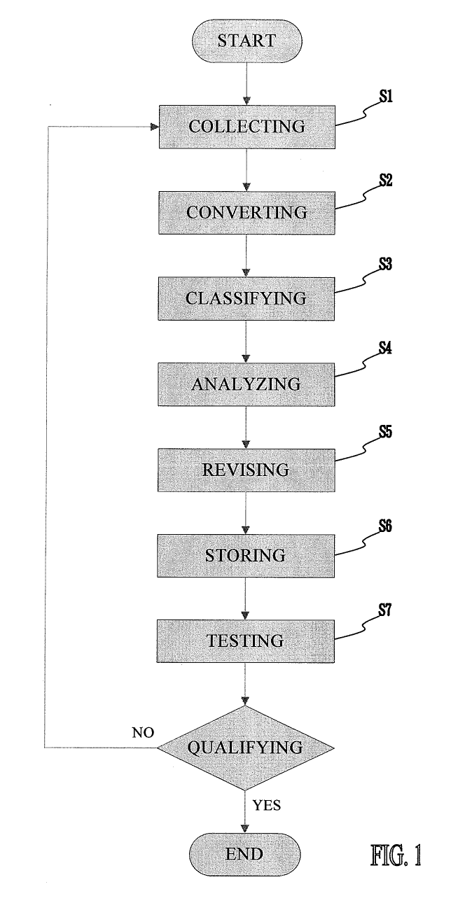

Referring now to FIG. 1, a flow chart of an establishing method of a multilingual translation database system in accordance with a preferred embodiment of the present invention is shown. The establishing method of the first embodiment of the present invention includes, by way of example, the steps of:
1. Collecting (identified as step S1): collecting multilingual texts via Internet by using an agent system, wherein the multilingual texts contain a plurality of multilingual sentence pairs or multilingual sentence-fragment pairs, each of the multilingual sentence pairs or the multilingual sentence-fragment pairs formed with a source language and a target language;
2. Converting (identified as step S2): converting the multilingual texts from a first format to a second format (target format);
3. Classifying (identified as step S3): classifying the multilingual texts according to particular or predetermined fields;
4. Analyzing (identified as step S4): analyzing the classified multilingual texts to select the multilingual sentence pairs or the multilingual sentence-fragment pairs from the classified multilingual texts, and to define or qualify a set of repeated key sentences or key sentence fragments of the repeated sentence structures or the repeated key sentence-fragment structures with a predetermined degree of repeat frequency;
5. Revising (identified as step S5): grammatically or terminologically revising the repeated key sentences or the key sentence fragments;
6. Storing (identified as step S6): adding the repeated key sentences or the key sentence fragments to the translation database; and
7. Testing (identified as step S7): testing the translation database to check whether the correctness of the repeated key sentences or the key sentence fragments meets a criteria or not.

Steps S1 through S7 must be repeatedly executed to complete the multilingual translation database system in accordance with the preferred embodiment of the present invention until passing the qualifying step.

With continued reference to FIG. 1, the establishing method of the second embodiment of the present invention includes, by way of example, the steps of:
1. Collecting (step S1): collecting multilingual texts via Internet by using an agent system, wherein the multilingual texts contain a plurality of multilingual sentence pairs or multilingual sentence-fragment pairs, and wherein the multilingual texts include technical web pages, electronic books, and online publications;
2. Converting (step S2): converting the multilingual texts from a first format (such as PDF-format or XML format) to a second format (target format) such that users can utilize a word processor to convert the multilingual texts into ordinary text-based documents;
3. Classifying (step S3): classifying digital files of the multilingual texts according to a particular or predetermined field (such as an anti-virus program field);
4. Analyzing (step S4): using a fuzzy matching technique to analyze the classified multilingual texts to select the multilingual sentence pairs or the multilingual sentence-fragment pairs from the classified multilingual texts, and to retrieve repeated key sentences or key sentence fragments of the repeated sentence structures or the repeated key sentence-fragment structures with a predetermined degree of repeat frequency;
5. Revising (step S5): grammatically or terminologically revising the repeated key sentences or the key sentence fragments;
6. Storing (step S6): adding the repeated key sentences or the key sentence fragments to the translation database; and
7. Testing (step S7): testing the translation database with a new text on computing equipment to check the correctness of the repeated key sentences or the key sentence fragments.

Steps S1 through S7 must be repeatedly executed to build the multilingual translation database system in accordance with the preferred embodiment of the present invention until passing the qualifying step.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. An establishing method for a multilingual translation database system, comprising the steps of:
collecting multilingual texts via Internet by using an agent system, wherein the multilingual texts contain a plurality of multilingual sentence pairs or multilingual sentence-fragment pairs, each of the multilingual sentence pairs or the multilingual sentence-fragment pairs formed with a source language and a target language;
converting the multilingual texts from a first format to a second format;
classifying the multilingual texts according to particular or predetermined fields;
analyzing the classified multilingual texts to select multilingual sentence pairs or multilingual sentence-fragment pairs from the classified multilingual texts, and to define a set of repeated key sentences or key sentence fragments of the repeated sentence structures or the repeated key sentence-fragment structures with a predetermined degree of repeat frequency;
revising the repeated key sentences or the key sentence fragments; adding the repeated key sentences or the key sentence fragments to the translation database; and
testing the translation database to check the correctness of the repeated key sentences or the key sentence fragments.

2. A method for building a multilingual translation database system, comprising the steps of:
providing a plurality of multilingual sentence pairs or multilingual sentence-fragment pairs in a translation database, each of the multilingual sentence pairs or the multilingual sentence-fragment pairs formed with a source language and a target language;
selecting repeated sentence structures or repeated sentence fragments from the multilingual sentence pairs or the multilingual sentence-fragment pairs;
defining at least one repeated key sentence or key sentence fragment of the repeated sentence structures or the repeated key sentence-fragment structures with a predetermined degree of repeat frequency.

3. The method as defined in claim 2, further comprising the step of:
collecting the multilingual sentence pairs or the multilingual sentence-fragment pairs via Internet by using a computer program.

4. The method as defined in claim 2, further comprising the step of:
converting a first format of the multilingual sentence pairs or the multilingual sentence-fragment pairs into a second format by using recognition software.

5. The method as defined in claim 2, further comprising the step of:
revising the repeated key sentence or the repeated key sentence fragment, and adding the repeated key sentence or the repeated key sentence fragment to the translation database.

6. A multilingual translation database system, comprising:
a translation database;
a plurality of multilingual sentence pairs or multilingual sentence-fragment pairs provided in the translation database;
a plurality of repeated sentence structures or repeated sentence-fragment structures selected from the multilingual sentence pairs or the multilingual sentence-fragment pairs;
a plurality of repeated key sentences or repeated key sentence fragments retrieved from the repeated sentence structures or the repeated sentence-fragment structures;
wherein each of the repeated key sentences or the repeated key sentence fragments has a predetermined degree of repeat frequency.

7. The multilingual translation database system as defined in claim 6, wherein the multilingual sentence pairs or the multilingual sentence-fragment pairs are collected via Internet by using a computer program.

8. The multilingual translation database system as defined in claim 6, wherein the multilingual sentence pairs or the multilingual sentence-fragment pairs are converted from a first format of into a second format by using recognition software.

9. The multilingual translation database system as defined in claim 6, wherein the repeated key sentences or the repeated key sentence fragments are revised and added to the translation database.
